(19) United States
(12) Patent Application Publication
(10) Pub. No.: US 2026/0189466 A1
(43) Pub. Date: Jul. 2, 2026

(54) System and Method to Enhance Network Simulation Accuracy Through Calibration and Model Optimization

(71) Applicant: Ciena Corporation, Hanover, MD (US)

(72) Inventors: Christopher Barber, Ottawa (CA); Maede Davoudzade, Ottawa (CA); Babak Esfandiari, Ottawa (CA); Thomas Kunz, Ottawa (CA)

(21) Appl. No.: 19/007,773

(22) Filed: Jan. 2, 2025

(51) Int. Cl. H04L 41/14; H04L 43/0852

(52) U.S. Cl. CPC H04L 41/145; H04L 43/0852

(57) ABSTRACT

A network simulation system and method including a network simulation including instructions stored in a memory and executed by a processor to simulate the operation of a network, and a processing delay model including instructions stored in a memory and executed by a processor to enable the network simulation to simulate the operation of the network incorporating processing delay, where the processing delay model includes an objective calibration function, where the network is operated responsive to the simulated operation of the network incorporating the processing delay. The processing delay model enables the network simulation to simulate the operation of the network incorporating processing delay via the objective calibration function using estimated calibration values.

### TECHNICAL FIELD

The present disclosure relates generally to the telecommunications and networking fields. More particularly, the present disclosure relates to a system and method to enhance network simulation accuracy through calibration and model optimization. Such network simulation is used as a digital twin of a network and/or to test changes to a network, with the network then being operated responsive to the network simulation and providing feedback to the network simulation.

### BACKGROUND

Network simulations are essential tools for researchers and engineers to test, analyze, and validate network protocols and designs before real-world implementation. Building and testing real networks is expensive and time-consuming, while network simulations provide a cost-effective alternative. Accurate network simulations are crucial for reliable, real-world-like results, helping fine-tune network parameters, diagnose issues, and plan upgrades by predicting performance impacts of changes.

Inaccurate network simulations can lead to flawed predictions of network performance, particularly for metrics like delay, bandwidth utilization, jitter, and packet loss. Underestimating or overestimating these metrics can cause network designers to make poor decisions. Real-world networks are complex due to traffic patterns, protocol interactions, and hardware constraints, which inaccurate network simulations may fail to capture, especially in critical areas like congestion control and packet loss. This can result in protocols and/or configurations that perform well in simulations but fail in real deployments. Inaccurate network simulations also undermine the credibility of research, slowing progress in networking studies. Simplified models can overlook real-world effects, leading to overly optimistic results. One such often-overlooked factor is processing delay, which can have a significant impact on network performance but is frequently simplified in simulations.

In simulation accuracy validation, comparing key metrics such as end-to-end delay is essential for capturing a comprehensive understanding of the network's behavior. End-to-end delay is a critical metric for ensuring that latency-sensitive applications meet quality of service (QoS) requirements.

End-to-end delay is the sum of four distinct delays: transmission delay, queuing delay, propagation delay, and processing delay. Transmission delay is the time it takes to push all the bits of a packet onto a link. Queueing delay is the time a packet spends waiting in a queue before it can be transmitted. Propagation delay is the time it takes for the signal to travel from the sender to the receiver. Processing delay refers to the time a router or network device spends handling a packet. This includes tasks such as decoding the packet header, checking for errors, routing table lookups, and making decisions about forwarding the packet to the next hop. Processing delay is influenced by factors such as the computational power of the router, the complexity of routing decisions, and the type of operations required, such as encryption or traffic filtering.

In many network simulations, processing delay is often ignored or simplified because it was historically considered negligible, especially when compared to other types of delays like transmission or propagation delays. However, as network devices increasingly perform more complex tasks, processing delay can become a significant component of overall network delay.

Ignoring processing delay in network simulations can lead to inaccurate predictions of network performance, particularly in scenarios where routers handle complex processing tasks. It is essential for realistic network simulations to incorporate processing delay, especially in modern high-speed networks where such delays are becoming more pronounced.

The present background is provided as environmental context only. It will be readily apparent to those of ordinary skill in the art that the concepts and principles of the present disclosure may be implemented in other environmental contexts equally, without limitation.

### SUMMARY

Thus, accurate network simulations are critical for replicating real-world performance and guiding design decisions. Improving the accuracy of these simulations, particularly with respect to end-to-end delay, requires careful calibration of parameters. One often overlooked factor is processing delay, which is typically simplified or ignored in network simulation tools, leading to inaccurate results. The present disclosure enhances network simulation accuracy by incorporating processing delay as a key parameter in the calibration process through a linear optimization approach. This adjustment reduces the discrepancy between network simulation outcomes and real-world network behavior. However, even after calibration, certain models may still fail to fully capture the complexity of real-world networking devices. In such cases, developing a new model is necessary to better reflect device-specific characteristics. To demonstrate this, examples are provided highlighting the limitations of existing simulation models and validating the effectiveness of the model of the present disclosure in accurately replicating real network conditions, particularly in terms of end-to-end delay.

The present disclosure provides a system and method aimed at enhancing the accuracy of network simulations by integrating processing delay as a fundamental parameter in the calibration process. Network simulations are critical for testing and validating network protocols and designs before deployment. However, traditional simulation models often overlook processing delay, potentially leading to significant discrepancies between simulated results and real-world network performance. The present disclosure addresses this gap by providing a systematic approach to calibrate simulation models, thereby improving their fidelity and reliability.

In some embodiments, the present disclosure provides a network simulation system including a network simulation including instructions stored in a memory and executed by a processor to simulate the operation of a network, and a processing delay model including instructions stored in a memory and executed by a processor to enable the network simulation to simulate the operation of the network incorporating processing delay, where the processing delay model includes an objective calibration function, where the network is operated responsive to the simulated operation of the network incorporating the processing delay. The network simulation simulates the operation of the network to determine predicted traffic delays in the network. In some embodiments, the network simulation initially simulates the operation of the network not incorporating the processing delay using received initial network performance data and generating initial network simulation results. The processing delay model compares the generated initial network simulation results to received subsequent network performance data to estimate calibration values for the objective calibration function of the processing delay model. The processing delay model enables the network simulation to simulate the operation of the network incorporating processing delay via the objective calibration function using the estimated calibration values. The processing delay model compares the generated initial network simulation results to received subsequent network performance data to validate the generated initial network simulation results to ensure accuracy and reliability with respect to predicting the operation of the network. In some embodiments, the network is operated responsive to the simulated operation of the network incorporating the processing delay using a digital twin network utilizing the simulated operation of the network of the network simulation.

In some embodiments, the present disclosure provides a network simulation method including simulating the operation of a network using a network simulation including instructions stored in a memory and executed by a processor, enabling the network simulation to simulate the operation of the network incorporating processing delay using a processing delay model including instructions stored in a memory and executed by a processor, where the processing delay model includes an objective calibration function, and operating the network responsive to the simulated operation of the network incorporating the processing delay. The network simulation simulates the operation of the network to determine predicted traffic delays in the network. In some embodiments, the network simulation method further includes initially simulating the operation of the network not incorporating the processing delay using the network simulation and received initial network performance data and generating initial network simulation results. The network simulation method further includes comparing the generated initial network simulation results to received subsequent network performance data using the processing delay model to estimate calibration values for the objective calibration function of the processing delay model. The processing delay model enables the network simulation to simulate the operation of the network incorporating processing delay via the objective calibration function using the estimated calibration values. The network simulation method further includes comparing the generated initial network simulation results to received subsequent network performance data using the processing delay model to validate the generated initial network simulation results to ensure accuracy and reliability with respect to predicting the operation of the network. In some embodiments, the network is operated responsive to the simulated operation of the network incorporating the processing delay using a digital twin network utilizing the simulated operation of the network of the network simulation.

In some embodiments, the present disclosure provides a non-transitory computer-readable medium including instructions stored in a memory and executed by a processor to carry out network simulation method steps including simulating the operation of a network using a network simulation including instructions stored in a memory and executed by a processor, enabling the network simulation to simulate the operation of the network incorporating processing delay using a processing delay model including instructions stored in a memory and executed by a processor, where the processing delay model includes an objective calibration function, and operating the network responsive to the simulated operation of the network incorporating the processing delay. The network simulation simulates the operation of the network to determine predicted traffic delays in the network. In some embodiments, the network simulation method steps further include initially simulating the operation of the network not incorporating the processing delay using the network simulation and received initial network performance data and generating initial network simulation results. The network simulation method steps further include comparing the generated initial network simulation results to received subsequent network performance data using the processing delay model to estimate calibration values for the objective calibration function of the processing delay model. The processing delay model enables the network simulation to simulate the operation of the network incorporating processing delay via the objective calibration function using the estimated calibration values. The network simulation method steps further include comparing the generated initial network simulation results to received subsequent network performance data using the processing delay model to validate the generated initial network simulation results to ensure accuracy and reliability with respect to predicting the operation of the network.

It will be readily apparent to those of ordinary skill in the art that aspects and features of each of the described embodiments may be incorporated, omitted, and/or combined as desired in a given application, without limitation.

### BRIEF DESCRIPTION OF THE DRAWINGS

The present disclosure is illustrated and described with reference to the various drawings, in which like reference numbers are used to denote like system components/method steps, as appropriate, and in which:

FIG. 1 illustrates one embodiment of the network simulation system of the present disclosure;

FIG. 2 illustrates one embodiment of the network simulation method of the present disclosure;

FIG. 3 illustrates a comparison of end-to-end delay across various network simulations against testbed results under varying data rates;

FIG. 4 illustrates a physical testbed setup used for experimentation, consisting of four routers and a traffic generator to create data flows across the network;

FIG. 5 illustrates a mean absolute error (MAE) comparison of end-to-end delays for various message lengths between a testbed and various network simulations for a router of the testbed setup;

FIG. 6 illustrates a MAE comparison of end-to-end delays for various message lengths between a testbed and various network simulations for another router of the testbed setup;

FIG. 7 illustrates end-to-end delay and packet loss behavior of a further router under a single traffic flow with 1500-byte packets and varying packet rates, as compared against network simulation results;

FIG. 8 illustrates observed end-to-end delay behavior of the further router for different message lengths, showing the linear relationship between packet size and delay;

FIG. 9 illustrates one embodiment of an algorithm for modeling delay;

FIG. 10 illustrates the packet rate versus delay diagram for a single flow originating from the further router in the network;

FIG. 11 illustrates validation scenarios for the further router including two flows with different packet rates and packet sizes; and

FIG. 12 illustrates a comparison of end-to-end delays for various message lengths between a testbed and a network simulations for the further router of the testbed setup

It will be readily apparent to those of ordinary skill in the art that aspects and features of each of the illustrated embodiments may be incorporated, omitted, and/or combined as desired in a given application, without limitation.

### DETAILED DESCRIPTION

Again, the present disclosure provides a system and method aimed at enhancing the accuracy of network simulations by integrating processing delay as a fundamental parameter in the calibration process. Network simulations are critical for testing and validating network protocols and designs before deployment. However, traditional simulation models often overlook processing delay, potentially leading to significant discrepancies between simulated results and real-world network performance. The present disclosure addresses this gap by providing a systematic approach to calibrate simulation models, thereby improving their fidelity and reliability.

The components of the system and method of the present disclosure include a processing delay model, an objective function for calibration, and a calibration process.

Related to the processing delay model, the present disclosure provides a linear model for processing delay that includes two main components:
a constant base cost per packet: this represents the fixed processing time required for each packet, regardless of size, and
an additional cost proportional to packet size: this accounts for the variable processing time that depends on the size of the packet being processed.

The processing delay model for a packet is mathematically represented as:

$${d}_{p r} = α + β \times 1$$

where α is the constant base cost, β is the coefficient representing the additional cost per unit of packet size, and l is the packet size.

Related to the objective function for calibration, the objective function is formulated to minimize the gap between traffic delay predicted by the simulation and the real-world network results. The objective function is designed to optimize the values of α and β in the per-packet processing delay model, ensuring that the simulation results closely match the observed performance in real-world scenarios.

Related to the calibration process, the calibration process involves the following steps:
data collection: collect real-world performance data from a physical network, including metrics such as end-to-end delay, packet loss, and throughput,
initial simulation: run network simulations (e.g., using the OMNeT++/INET framework) to predict the expected traffic delays in the real network without incorporating processing delay,
parameter estimation: use the discrepancy between the collected network data and the network simulation outputs to estimate the values of α and β for the processing delay model, and
validation: validate the calibrated model by comparing the optimized network simulation results with additional network data to ensure accuracy and reliability.

The present disclosure provides a more accurate and reliable system and method for network simulations, enabling better decision-making and network design. It enhances the accuracy of what-if scenarios, improving the ability to predict and diagnose network performance issues, and reducing the risk of deployment failures. The calibrated simulation models can be used in various applications, including protocol testing, network optimization, and performance evaluation. By addressing the limitations of traditional models and providing a systematic calibration process, the present disclosure offers a practical and effective solution for improving the accuracy and reliability of network simulations.

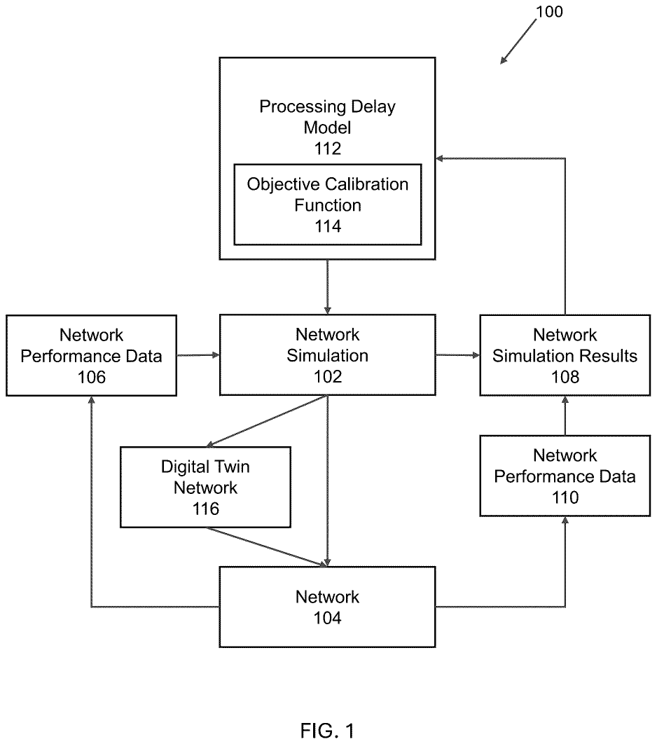

FIG. 1 illustrates one embodiment of the network simulation system 100 of the present disclosure. The network simulation system 100 includes a network simulation 102 that includes non-transitory computer-readable medium instructions stored in a memory and executed by a processor to simulate the operation of a real-world network 104 including physical, logical, and/or hybrid components, such as processing devices, memory devices, controllers, nodes, routers, switches, links, etc. for transmitting and receiving packets. The network simulation 102 receives real-world network performance data 106, which could be from the real-world network 104 or from another real-world network, and includes metrics such as end-to-end delay, packet loss, and throughput. The network simulation 102 runs an initial network simulation using the real-world network performance data 106 to predict expected traffic delays in the real-world network 104 without incorporating processing delay. The network simulation results 108 from the network simulation 102 are then compared to collected network performance data 110, which could again could be from the real-world network 104 or from another real-world network, to estimate the values of α and β for the processing delay model 112. The objective calibration function 114 is utilized as part of the processing delay model 112 to minimize the gap between the traffic delay predicted by the network simulation 102 and the real world network 104. The network simulation 102 is then run incorporating the processing delay model 112, again generating network simulation results 108. Finally, the calibrated network simulation 102 is validated by comparing the network simulation results 108 with additional collected network performance data 110 to ensure accuracy and reliability. The network simulation 102 may then be used as a digital twin network 116 for the real-world network 104 and/or to control the operation of the real-world network 104, with processing delay now being fully accounted for.

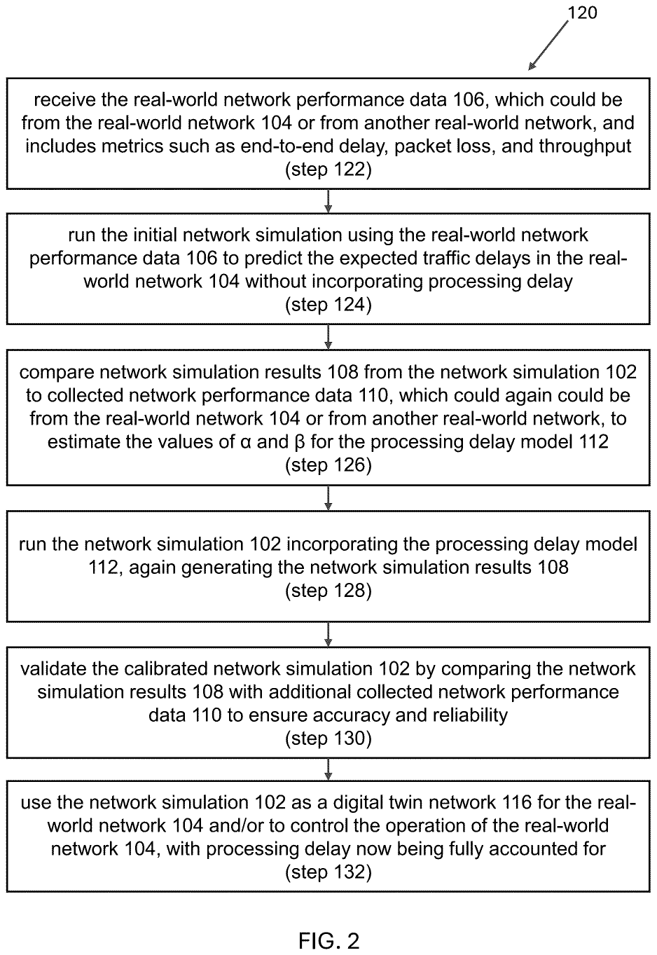

FIG. 2 illustrates one embodiment of the network simulation method 120 of the present disclosure. The network simulation method 120 involves the operation of the network simulation 102. The network simulation 102 receives the real-world network performance data 106, which again could be from the real-world network 104 or from another real-world network, and includes metrics such as end-to-end delay, packet loss, and throughput (step 122). The network simulation 102 runs the initial network simulation using the real-world network performance data 106 to predict the expected traffic delays in the real-world network 104 without incorporating processing delay (step 124). The network simulation results 108 from the network simulation 102 are then compared to collected network performance data 110, which could again could be from the real-world network 104 or from another real-world network, to estimate the values of α and β for the processing delay model 112 (step 126). The objective calibration function 114 is utilized as part of the processing delay model 112 to minimize the gap between the traffic delay predicted by the network simulation 102 and the real world network 104. The network simulation 102 is then run incorporating the processing delay model 112, again generating the network simulation results 108 (step 128). Finally, the calibrated network simulation 102 is validated by comparing the network simulation results 108 with additional collected network performance data 110 to ensure accuracy and reliability (step 130). The network simulation 102 may then be used as a digital twin network 116 for the real-world network 104 and/or to control the operation of the real-world network 104, with processing delay now being fully accounted for (step 132). It should be note that all method steps may be carried out by non-transitory computer-readable medium instructions stored in a memory and executed by a processor.

The present disclosure thus incorporates processing delay as a key parameter in the network simulation calibration. The present disclosure provides a linear model for processing delay that includes both a constant base cost per packet and an additional cost proportional to packet size. An objective function is specifically designed to minimize the delay gap between the network simulation results and the real-world network performance.

Prior to the present disclosure, network simulations typically neglected processing delay, sometimes leading to inaccurate predictions of network performance. Existing models primarily focused on queueing delay and bandwidth utilization but failed to account for the significant impact of processing delay on end-to-end delay, packet loss, and throughput. Traditional network simulation tools were limited in capturing real-world network behavior, especially under high-load or congested conditions.

Thus, conventional network simulations provide inaccurate predictions of network performance due to the omission of processing delay. These simplified models fail to capture the complexity of real-world networks, leading to flawed predictions of delay, packet loss, and throughput. Further, static simulation tools are unable to adapt to dynamic traffic conditions and specific router behaviors.

The present disclosure addresses the shortcomings of known solutions by incorporating processing delay into the network simulation models. The linear model for processing delay accounts for both a constant base cost per packet and an additional cost proportional to packet size. The calibration process involves comparing simulation results with real-world physical network results and adjusting processing delay parameters to minimize discrepancies. This approach ensures that simulation models more accurately reflect the behavior of actual network devices under various traffic conditions.

The objective function of the present disclosure serves to minimize the delay gap between network simulation results and the physical network by calibrating the processing delay. To this end, the objective function is defined as below:

$$min ( {\sum }_{j = 1}^{\vert F \vert} ( {d}_{{network}_{{f}_{j}}} - ( {d}_{s {imulation}_{{f}_{j}}} + {\sum }_{n = 1}^{\vert N \vert} {ω}_{n , {f}_{j}} ( {\sum }_{k = 1}^{\vert P \vert} {d}_{p r o {c}_{n}} ) ) ) ) [ {∀}_{{f}_{j}} ∈ {F}_{i} ]$$

where:
(Fᵢ) is the set of flows in the network,
(fᵢ) is a single flow from (Fᵢ),
(d_{network}_{_{fj}}) is the measured end-to-end delay for flow (fⱼ) in the physical network,
(dₛᵢₘᵤₗₐₜᵢₒₙ_{_{fj}}) is the predicted end-to-end delay for flow (fⱼ) in the network simulation,
(N) is the total number of nodes in the network,
(ω) is a selection function which represents the existence of node (n) in the flow (fⱼ); it returns 0 if node (i) is not in the path taken by flow (j), otherwise it returns 1, and
(d_{proc}_{ₙ}) is the processing delay of node n.
(Pₖ) is representing the packets in flow (fⱼ).

The constraints are:
The processing delay for each node must be non-negative: (0≤d_{proc}_{ₙ}),
If there is no flow passing through node (n), then (d_{proc}_{ₙ}) is 0, and
The range of values for processing delay is constrained per node to (0≤d_{proc}_{ₙ}≤Θ), where Θ is defined as the maximum gap between the physical network and simulation: (Θ=Max(d_{network}−dₛᵢₘᵤₗₐₜᵢₒₙ); in other words, the processing delay assigned to a node should not exceed the maximum delay gap observed between the physical network and the network simulation.

A linear model for processing delay is introduced, which accounts for both a constant base cost per packet and an additional cost proportional to packet size:

$${d}_{p r o {c}_{n , k}} = {α}_{n} + {β}_{n} * {l}_{k}$$

where:
(d_{proc}_{_{n,k}}) represents the processing delay for a single packet (k) in the node (n),
(αₙ) is a constant processing delay per packet for node (n); this cost accounts for operations that are required for every packet, such as reading the header, performing routing table lookups, and basic error checking; these operations are fixed and apply equally to all packets, irrespective of their length,
(βₙ) is the delay per packet per byte for node (n); this component reflects the increased complexity and time required for processing larger packets, which involve tasks such as memory handling, payload inspection, encryption, and checksum calculations; since these tasks become more resource-intensive as packet size increases, (β) is a proportional factor that adjusts the processing delay based on the message length, and
(lₖ) is the packet size of packet (k).

Finally, the average processing delay for node (n) is computed as:

$${d}_{p r o {c}_{n}} = \frac{1}{K} {\sum }_{k = 1}^{K} {d}_{p r o {c}_{n , k}}$$

By minimizing the objective function, the calibration process ensures that the network simulation model accurately reflects the real-world network performance, thereby improving the fidelity and reliability of network simulations. The objective function can be minimized using optimization techniques such as gradient descent, least squares minimization, or other suitable methods.

The system and method of the present disclosure were validated through a series of experiments using a physical testbed, consisting of five routers from three different series. The experiments demonstrated that neglecting processing delay in network simulations leads to significant inaccuracies, particularly in modern, high-speed networks. By incorporating the calibrated processing delay model, the simulations showed improved accuracy in predicting end-to-end delay, closely matching the real-world network performance observed in the testbed.

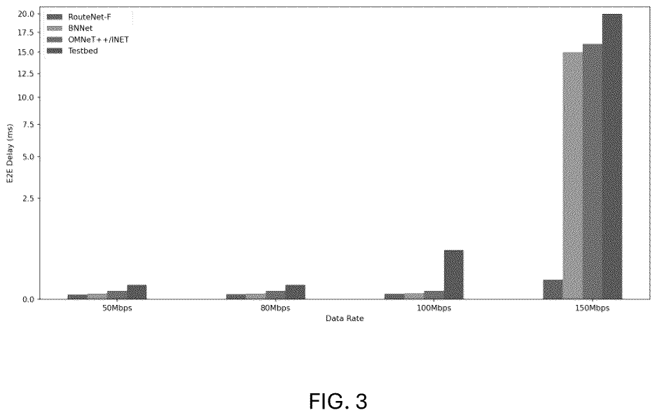

A case study was also conducted using a real network, with the objective of building a simulation model that accurately replicates the real network. Two routers that were directly connected together and end-to-end delay was measured across multiple simulation tools, including RouteNet Fermi, BNNet, and OMNeT++. Consistent configurations were maintained, such as a 100 Mbps link bandwidth, 1,600,000-bit buffer size, and a uniform traffic setup with 200-byte message lengths. Data rate variations are shown in FIG. 3. RouteNet Fermi, which requires training on real network data, exhibited notable performance gaps as compared to the testbed, particularly under high-load scenarios. In contrast, BNNet and OMNeT++ produced more accurate delay predictions. These results are shown in FIG. 3.

Ultimately, OMNeT++/INET was selected as the primary simulation tool for its flexibility in handling packet sizes and its reliability without the need for additional training. The remainder of this case study focused on improving the accuracy of OMNeT++/INET network simulations to minimize the gap between model and real network performance.

Again, end-to-end delay is the sum of four distinct delays: transmission delay, queuing delay, propagation delay, and processing delay. Transmission delay is the time it takes to push all the bits of a packet onto a link. Queueing delay is the time a packet spends waiting in a queue before it can be transmitted. Propagation delay is the time it takes for a signal to travel from a sender to a receiver. Processing delay refers to the time a router or network device spends handling a packet. This includes tasks such as decoding the packet header, checking for errors, routing table lookups, and making decisions about forwarding the packet to a next hop. Processing delay is influenced by factors such as the computational power of the router, the complexity of routing decisions, and the type of operations required, such as encryption or traffic filtering.

In many network simulations, processing delay is ignored or simplified because it was historically considered negligible, especially as compared to other types of delays like transmission or propagation delays. However, as network devices increasingly perform more complex tasks, processing delay can become a significant component of overall network delay. Ignoring processing delay in simulations can lead to inaccurate predictions of network performance, particularly in scenarios where routers handle complex processing tasks. It is essential for realistic network simulations to incorporate processing delay, especially in modern high-speed networks where such delays are becoming more pronounced.

The present disclosure improves the accuracy of network simulations, specifically with respect to end-to-end latency, by incorporating processing delay as a key factor in the calibration process. While calibration helps reduce discrepancies, sometimes network simulation models may still fall short in capturing the full complexity of real-world networking devices, highlighting the need for developing new models. To address this, a refined model is introduced that better represents device-specific characteristics and its effectiveness is validated through this case study.

Numerous studies have focused on assessing the accuracy of simulation models. For instance, one study compares the results of two widely used simulators, OPNET Modeler and NS-2, against data from a real network testbed to validate their accuracy. Similarly, another study examines the performance and scalability of several network simulators, including NS-2, OMNeT++, NS-3, SimPy, and JIST/SWANS, by implementing identical simulation setups across these tools. These studies highlight the importance of ensuring that network simulation results align closely with real-world network behavior.

Model calibration ensures a network simulation model accurately represents the system it emulates. One study highlights the inherent complexity of model calibration, defining it as tuning model parameters to match the input-output behavior of a reference system. The study shows model calibration can be NP-complete and therefore, heuristic or approximate solutions are recommended. Another study presents an optimization method for tuning parameters of middleware services in wireless sensor networks to improve Quality of Service (QoS) metrics like accuracy, response time, and power consumption. Also, a study explores automated calibration methods for simulators in parallel and distributed computing, showing that algorithms like Grid Search, Random Search, and Gradient Descent can improve accuracy and reduce expert intervention, often outperforming manual methods in aligning simulations with real-world execution traces.

In all the studies, the authors relied on the network simulation models to replicate the behavior of real networking devices. However, existing network simulations may fail to accurately reflect the behavior of devices like routers due to specific configurations, making calibration insufficient. Static virtualization technologies often fall short of delivering the required QoS, especially under variable traffic loads. Traditional static resource allocation for virtual routers results in inefficient use of resources and difficulties in meeting delay requirements for real-time traffic. To address this, a dynamic resource reconfiguration model has been used that manages CPU and memory more effectively under fluctuating traffic demands. Likewise, some tools are limited in capturing real-world network behavior, particularly under high-load or congested conditions, as the tools are unable to adapt to the dynamic requirements of modern networks regarding routing, security, and resource allocation. While these studies provide valuable insights into simulation, validation, and calibration, they fall short in accounting for the role of processing delay as a key parameter.

The present disclosure addresses this gap by integrating processing delay into simulation models through a calibration process, offering a more accurate calibration method. Even with this improved calibration, sometimes simulation models may still fail to capture the complexities of real-world networking devices. To address this limitation, the present disclosure proposes a refined model that better reflects device-specific characteristics and validates its effectiveness through this case study. The case study is structured around two main tasks: validating the network simulation model and calibrating the network simulation model. Beginning by evaluating the accuracy of the network simulation model, if a significant gap is identified between the network simulation results and the real network data, the model is calibrated by incorporating processing delay as a key parameter. After the calibration, the model is re-evaluated to determine if the discrepancies have been minimized. However, if a significant gap persists, whether the simulation model accurately replicates the behavior of the actual network device is questioned. In such cases, a new model may need to be developed, tailored specifically to the device's behavior to improve simulation accuracy.

The evaluation process begins with hypothesis tests to determine if there are significant differences between the simulation model and the ground truth, helping to assess whether these discrepancies are statistically meaningful. Following this, correlation tests are conducted to evaluate the strength and reliability of the model by examining how well its outputs align with the ground truth in terms of trends and relationships. Finally, an error function is calculated, which plays a key role in the calibration and optimization of the simulation by quantifying the differences between the observed and simulated values.

To enhance the accuracy of the network simulation, a simulation model M is introduced, defined as a triple (X_{M}, P_{M}, Y_{M}), where X_{M} is the input, P_{M} is the set of parameters, and Y_{M} denotes the output metrics. The reference system, the testbed, has specific input values X_{S} and corresponding output values Y_{S}. The objective is to adjust the model parameters P_{M} so that the model's output Y_{M} matches the reference system's output Y_{S} for given inputs. The inputs, X_{M}, include detailed network configuration, such as nodes, links, queues, and flows, while the outputs Y_{M} measure key network performance metrics, including loss, throughput, and end-to-end delay. If the model outputs Y_{M} differ significantly from Y_{S}, a calibration is performed by adjusting P_{M}, specifically incorporating processing delay as a critical factor.

The inputs, Xₖ, include the network configuration, such as a set of nodes Nₖ, a set of links Lk, a set of queues Qₖ, and a set of flows Fₖ. These inputs collectively define the environment in which the network operates and manage traffic, determining performance metrics. Further, each lᵢ in L can be defined as a tuple:

$${l}_{i} = ( s r {c}_{i} , des {t}_{i} , {b}_{i} , {length}_{i} ) ; ∀ {l}_{i} ∈ L$$

where:
srcᵢ is the source node of the link lᵢ,
destᵢ is the destination node of the link lᵢ,
bᵢ is the bandwidth of the link lᵢ, and
lengthᵢ is the length of the link lᵢ.

Similarly, a set of output queues exist:

$$Q = \{ {q}_{i} : i ∈ ( 1 , … , \vert L \vert ) \}$$

where each queue can be defined as:

$${q}_{i} = ( {l}_{i} , {s}_{q i} , {p}_{q i} )$$

where:
lᵢ is the link that includes this outgoing queue,
s_{qi} is the size of the output queue in i-th queue, and
p_{qi} is the policy of the output queue in i-th queue which can be FIFO, WFQ, RED, and so on.

Flows follow a source-destination path. Hence, flows are defined as sequences with tuples of the queues and links they traverse along with the message length and packet rate of the flow:

$${f}_{i} = \{ ( {q}_{F q ( f i , 0} ) , {l}_{Fl ( fi , 0 )} , {m}_{i} , {s}_{i} , {t}_{i} ) , … , ( {q}_{F q ( f i , n q )} , {l}_{F l ( f i , nl )} , {m}_{i} , {s}_{i} , {t}_{i} ) \}$$

To summarize, fᵢ can be defined as below:

$${f}_{i} = ( {Q}_{f i} , {L}_{fi} , {m}_{i} , {s}_{i} , {t}_{i} )$$

This can be further expanded as:

$$F = \{ ( {L}_{f i} , {Q}_{f i} , {m}_{i} , {s}_{i} , {t}_{i} ) : i ∈ ( 1 , … , {n}_{f} ) \}$$

where:
F_{q(fi, j)} returns the index of the j-th queue in the network that is part of the path taken by flow fᵢ,
F_{l(fi, j)} returns the index of the j-th link in the network that is part of the path taken by flow fᵢ,
L_{fi} represents all the links that the i-th flow is taking,
Q_{fi} represents all the queues that the i-th flow is taking, mi represents the message length of the i-th flow,
sᵢ is the packet rate of the i-th flow,
tᵢ is the shape of the traffic for the i-th flow,
n_{q} is the number of queues in the path,
nₗ is the number of links in the path, and
n_{f} is the number of flows in Xi

Therefore, the input X is a set of Xₖ:

$$\begin{matrix}X = \{ {X}_{k} : k ∈ ( 0 , … , n ) \} \\ {X}_{k} = ( {N}_{k} , {L}_{k} , {Q}_{k} , {F}_{k} )\end{matrix}$$

The output Y_{M} is the set of metrics for all flows that can be represented as:

$$Y = \{ {Y}_{k} : k ∈ ( 1 , … , n ) \}$$

where each output Yₖ includes metrics such as loss, throughput, and end-to-end delay:

$${Y}_{k} = \{ ( {f}_{j l} , {f}_{jd} , {f}_{j t} ) : ∀ {f}_{j} , j ∈ ( 1 , … , nf ) \}$$

where:
fⱼₗ is the packet loss for flow fⱼ,
fⱼₜ is the throughput for flow fⱼ,
f_{jd} is the end-to-end delay for flow fⱼ, and
n_{f} is the number of flows.

Each metric in the output captures different aspects of network performance. Throughput measures the efficiency of data transfer, indicating the network's capacity to handle traffic. Loss measures the reliability of data transfer, showing how often packets are lost due to congestion or errors. Together, they provide a complete picture of network behavior making our simulation reliable and robust. The end-to-end delay is influenced by the intricate relationship between traffic demand, network topology, and network performance. The total end-to-end delay is given by:

$${D}_{totalj} = {D}_{transj} + {D}_{propj} + {D}_{procj} + {D}_{queuej}$$

where:
Dₜₒₜₐₗⱼ represents the total delay for a flow, which is the end-to-end delay,
Dₜᵣₐₙₛⱼ is the total transmission delay over each link on the path of flow j,
Dₚᵣₒₚⱼ is the total propagation delay over each link on the path of flow j,
D_{procj} is the total processing delay for each node on the path of flow j, and
D_{queuej} is the queuing delay for each outgoing interface on the path of flow j.

Transmission delay for a flow refers to the time it takes to push all the bits of a packet onto the links that the flow traverses. For flow j, the total transmission delay is the sum of the transmission delays for all links [symbol] on the path of flow j. The transmission delay for each link is a function of the message length mⱼ and the transmission rate bᵢ of the link. The total transmission delay for flow j is defined as:

$${D}_{trans} ( j ) = {\sum }_{i ∈ path ( j )} \frac{{m}_{j}}{{b}_{i}}$$

where:
Dₜᵣₐₙₛ(j) is the total transmission delay for flow j,
mⱼ is the message length for flow j, and
bᵢ is the transmission rate of link lᵢ on the path of flow j.

Propagation delay refers to the time it takes for a signal to travel from the sender to the receiver along each link in the path of the flow. For flow j, the total propagation delay is the sum of the propagation delays for all links [symbol] in the path of the flow. Propagation delay depends on the distance, which was previously defined as lengthᵢ, between the sender and receiver on link [symbol] and the speed of the signal sᵢ, which is typically close to the speed of light (commonly approximated for propagation delay as 2×108 m/s).

The total propagation delay for flow j is defined as:

$${D}_{p r o p} ( j ) = {\sum }_{i ∈ path ( j )} \frac{{length}_{i}}{{s}_{i}}$$

where:
Dₚᵣₒₚ(j) is the total propagation delay for flow j,
lengthᵢ is the distance between the sender and receiver on link [symbol] , and
sᵢ is the signal speed on link [symbol] .

P_{M} plays a fundamental role in aligning the simulation model with the real-world testbed. The goal is to minimize the gap between the simulation and the testbed by considering processing delay for each router. Although transmission and propagation delays can be easily measured or estimated, and queuing delay is typically calculated by simulation tools, processing delay is often overlooked in the overall delay calculation within these tools. However, it plays a significant role in the behavior of modern routers, especially under high-load traffic conditions. Therefore, P_{M} is defined as the set of processing delays per node:

$$P = \{ {d}_{p r o c i} : i ∈ ( 0 , … , \vert N \vert ) \}$$

The objective function of the present disclosure serves to minimize the delay gap between network simulation results and the testbed by calibrating the processing delay. To this end, the objective function is defined as below:

$$min ( {\sum }_{j = 1}^{\vert F \vert} ( {d}_{{network}_{{f}_{j}}} - ( {d}_{s {imulation}_{{f}_{j}}} + {\sum }_{n = 1}^{\vert N \vert} {ω}_{n , {f}_{j}} ( {\sum }_{k = 1}^{\vert P \vert} {d}_{p r o {c}_{n}} ) ) ) ) [ ∀ {f}_{j} ∈ {F}_{i} ]$$

where:
(Fᵢ) is the set of flows in the network,
(fⱼ) is a single flow from (Fᵢ),
(d_{testbedfj}) is the measured end-to-end delay for flow (fⱼ) in the testbed,
(d_{simulationsfj}) is the predicted end-to-end delay for flow (fⱼ) in the network simulation,
(N) is the total number of nodes in the network,
(ω) is a selection function which represents the existence of node (n) in the flow (fⱼ); it returns 0 if node (i) is not in the path taken by flow (j), otherwise it returns 1, and
(d_{proc}_{ₙ}) is the processing delay of node n.
(Pₖ) is representing the packets in flow (fⱼ).

The constraints are:
The processing delay for each node must be non-negative: (0≤d_{proc}_{ₙ}),
If there is no flow passing through node (n), then (d_{proc}_{ₙ}) is 0, and
The range of values for processing delay is constrained per node to (0≤d_{proc}_{ₙ}≤Θ), where Θ is defined as the maximum gap between the testbed and simulation: (Θ=Max (d_{testbed}−dₛᵢₘᵤₗₐₜᵢₒₙ)); in other words, the processing delay assigned to a node should not exceed the maximum delay gap observed between the testbed and the network simulation.

A linear model for processing delay is introduced, which accounts for both a constant base cost per packet and an additional cost proportional to packet size:

$${d}_{p r} = α + β * l$$

where:
(dₚᵣ) represents the processing delay for a single packet in the router,
(α) is a constant processing delay per packet; this cost accounts for operations that are required for every packet, such as reading the header, performing routing table lookups, and basic error checking; these operations are fixed and apply equally to all packets, irrespective of their length,
(β) is the delay per packet per byte; this component reflects the increased complexity and time required for processing larger packets, which involve tasks such as memory handling, payload inspection, encryption, and checksum calculations; since these tasks become more resource-intensive as packet size increases, (β) is a proportional factor that adjusts the processing delay based on the message length, and
( [symbol] ) is the packet size.

In the linear problem defined by the objective function and the constraints listed above, the total processing delay is established for each router in the network. The is to introduce processing delays that accurately reflect the behavior of each router. Using the model, the optimal values of α and β are identified for each router. Finally, the model refines the calculation of d_{proc}_{ₙ}, where the total processing delay for each router is based on the traffic passing through it.

$${d}_{p r o {c}_{n}} = α + β * {l}_{j}$$

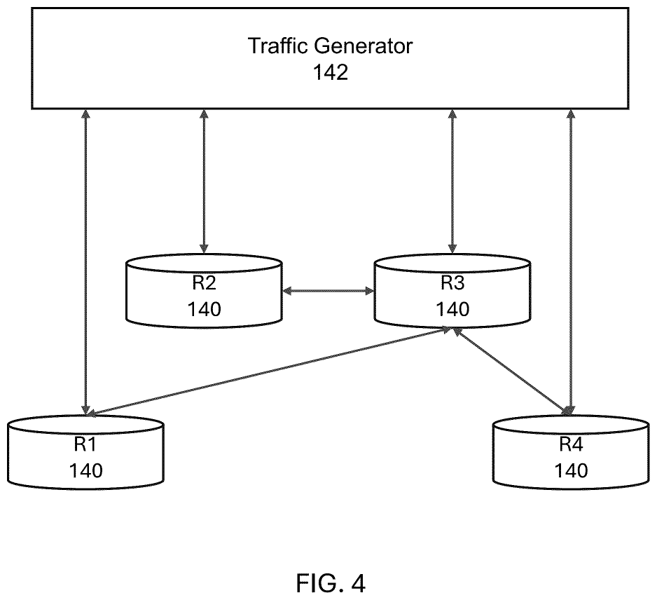

To validate the approach of the present disclosure and minimize the gap between the testbed and simulation results, a series of experiments were conducted using a physical testbed represented in FIG. 4, consisting of four routers 140 from three different series, with a traffic generator (IXIA) 142 to create data flows across the network. The aim is to calibrate processing delay by comparing the testbed results with OMNeT++/INET simulations. The primary objective of the experiments is to adjust the simulation to more accurately reflect real-world behavior by tuning the processing delay parameters. Routers with 100 Mbps links were used across the network, except for the links connected to IXIA, which were set to 1 Gbps. This configuration allowed the introduction of various traffic scenarios and examining the impact of processing delay under different conditions. The overall topology of the testbed is illustrated in FIG. 4. The run time for each experiment in both environments was 12 s and each experiment was repeated multiple times to make sure that the result is reliable. Flows were set up with varying message lengths to observe the behavior of each router under different traffic conditions. The focus was on router R2 140 to measure end-to-end delay and identify potential discrepancies between testbed and network simulation results. Calibrated values of processing delay parameters α and β for router R2 140 were β 0.85 ns/byte and α 5 ns.

The main objective of the calibration process is to determine the optimal values for the processing delay parameters, a and, for each router. Testing began by evaluating router R2 140 through a series of experiments involving a single traffic flow with a message length of 300 bytes, and adjusting the data rate between 50 Mbps and 150 Mbps to simulate different network loads. The queue capacity was set to 500 packets, and each experiment was run for 12 s in both the testbed and network simulation environments. After 14 different experiments on this router 140, there was no significant difference in the delay between the testbed and the network simulation when traffic levels were low. However, as the traffic load increased and router R2 140 became congested, a delay gap was observed between the testbed and the network simulation results. This behavior is consistent with observations in previous works, which highlight the impact of congestion on processing delay. Once the queue reached capacity, the end-to-end delay stabilized, as did the delay gap. This behavior indicates that after the queue is full, additional packets are dropped, resulting in a relatively constant processing delay for the packets still being processed. The values for α and β obtained from this experiment are summarized above.

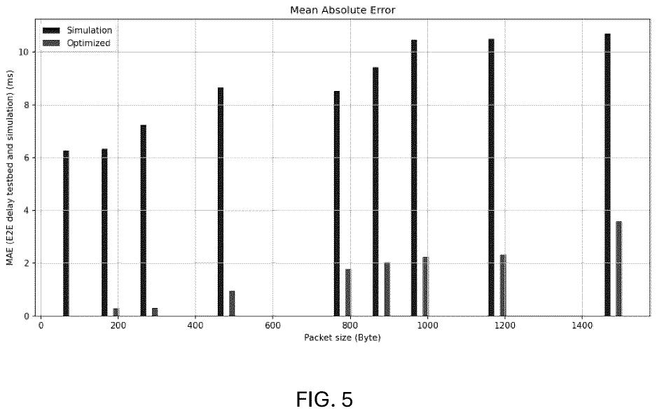

To validate the calibration and verify the values obtained in the previous step, further experiments were conducted using a range of message lengths from 100 to 1500 bytes. Each experiment ran for 12 s in both the network simulation and real testbed environments, with a fixed data rate of 150 Mbps to evaluate the model's performance under high traffic conditions. FIG. 5 illustrates mean absolute error (MAE) of the end-to-end delay results, showing that the calibrated model (optimized) significantly reduced the delay gap between OMNeT++ and the testbed. The ideal case is shown where the both end-to-end delays match. As shown, the linear optimization model closely follows this ideal line, demonstrating its effectiveness in minimizing the delay gap between the network simulation and the real-world testbed.

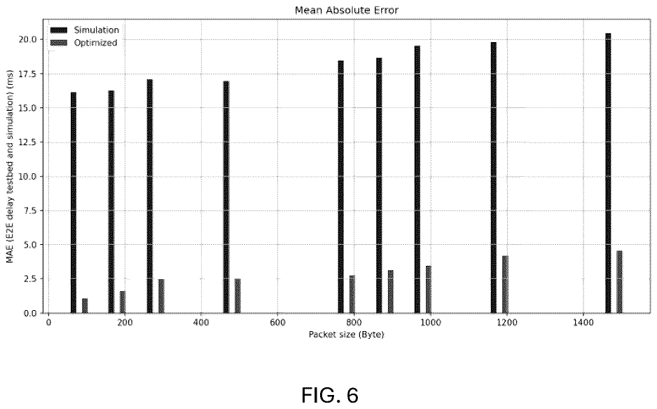

The same experiments were then conducted on router R3 140. The results for this router 140 showed slight variations compared to the previous experiments, which is consistent with findings from prior studies. These studies highlight that processing delay is influenced by the specific design and architecture of each router 140, meaning different types of routers 140 can exhibit varying processing delays. The values obtained for router R3 140 were β 1.3 ns/byte and a 10 ns. Additionally, the same experiments were conducted on router R2 140 to validate the values obtained for this router 140. FIG. 6 provides a MAE comparison of end-to-end delays for various message lengths between the testbed, OMNeT++, and the calibrated OMNeT++ model for router R3 140.

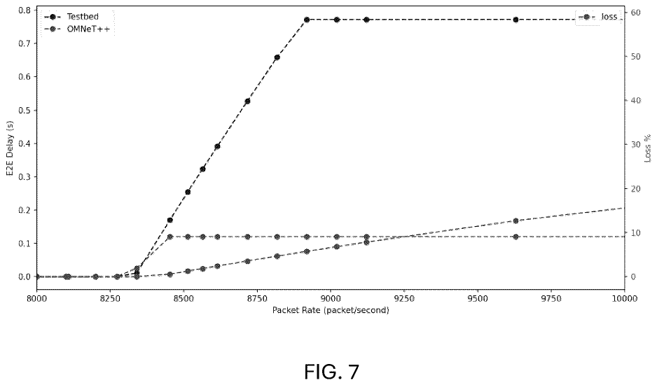

FIG. 7 shows end-to-end delay and packet loss behavior of router R1 140 under a single traffic flow with 1500-byte packets and varying packet rates, compared against OMNeT++ simulation results. The calibrated model effectively reduces the delay gap for router R3 140 as well. Up to this point, the simulation model has successfully been calibrated for routers in two series. Now, the focus shifts to calibrating router R1 140 and router R4 140 from a different series. Traffic with 1500-byte messages was sent, and the packet rates are shown on the x-axis in FIG. 7, and each experiment is run for 12 s. With a 100 Mbps link, the network can handle 8333 packets per second. The queue size was set to 12000000 bits, resulting in an expected queuing delay of 0.12 seconds. One line represents the expected behavior once the queue is full with end-to-end delay 0.12 s. Another line shows packet loss corresponding to OMNeT++/INET. The delay of this router is shown by a further line, for packet rates below 8333 packets per second, the delay matched simulation results. However, when the rate exceeded 8333 packets per second, queuing increased, causing higher delays and packet loss. Contrary to expectations, the delay rose linearly, stabilizing at 0.78 seconds, indicating potential issues with the router under congestion. Clearly, this router was not operating as expected, i.e., as modeling in the OMNeT++/INET router model, given the configuration parameters. Thus, a modified delay model was needed, as discussed below, to ensure that the network simulation closely matches the results from the testbed.

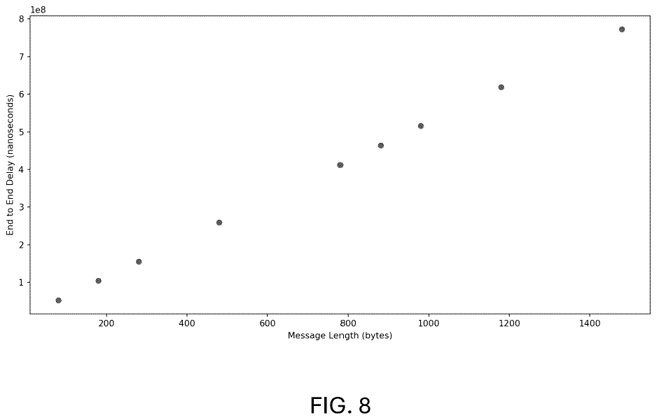

To accurately model the router's behavior, a refined model of the delay introduced by that router is needed. For example, FIG. 8 illustrates how delay changes with varying packet sizes. The data rate was set to a high value to observe the delay behavior when the queue reaches full capacity. FIG. 8 demonstrates an almost linear relationship between packet size and delay, which can be further explained by the equation:

$$E 2 E D e l a y ( u s ) = δ * MessageLeng th ( bytes ) + κ$$

One can replace the numbers based on the router behavior, for example for router R1 this provides:

$$E 2 E D e l a y ( u s ) = 510 ( us / bytes ) * MessageLength ( bytes ) + 8850 ( u s )$$

To accurately model the linearity observed before reaching the maximum delay, it is important to understand how the slope changes based on different packet sizes. To identify the appropriate range of packet rates where the delay begins to increase linearly until it reaches its maximum value, a series of experiments were conducted for each packet size. From these experiments, it was observed that for nearly all packet sizes, the delay starts to grow in a linear fashion as the packet rate increases. This linear behavior occurs within a specific range of packet rates, defined by [PRT, PRT+γ]. The term Packet Rate Threshold (PRT) represents the point at which this linear increase begins, and γ denotes the range where the delay continues to rise linearly until it stabilizes. This range is referred to as the linear threshold, captured by γ.

The objective is to develop a model that accurately captures the behavior of the router, particularly in terms of delay. The model represents a list of flows, each characterized by a pair consisting of a packet rate and message length. If the total traffic load exceeds the available bandwidth of the link, the network will experience congestion, resulting in packet loss and delays. Based on the observations from router R1 140, it was noted that the total packet loss is distributed equally among all flows, meaning each flow experiences the same percentage of loss. For example, with two flows [(1500, 5000), (1000, 8000)], the combined traffic rate amounts to 15,500,000 bytes, exceeding the link's capacity by 3,000,000 bytes. As a result, one would expect an overall packet loss of approximately 19.3%, and each flow would experience this same percentage of loss. This behavior has been consistently observed across multiple experiments, confirming that it is not a scenario-specific occurrence.

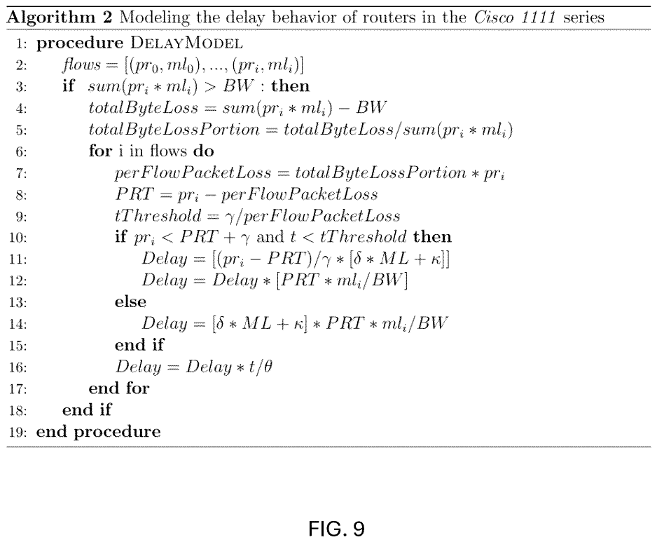

To model the delay, the algorithm shown in FIG. 9 is provided. This algorithm replicates the behavior of router R1 140 by predicting the end-to-end delay for any combination of flows. Observations indicate that the delay is influenced by the flows traversing the same link, so the algorithm focuses on calculating the delay based on these flow characteristics. The first step is to determine if the given set of flows causes congestion in the link. If congestion is detected (line 1), one then needs to calculate the actual packet rate for each packet, i.e., the number of packets successfully transmitted per second for each flow. This is done by computing the total packet loss and loss portion (lines 4 and 5), as described above. Once the total packet loss is known, the number of packets lost per second for each flow is calculated (line 7). By subtracting this value from the original packet rate, one can determine the number of packets successfully transmitted per second for each flow (line 8). If the packet rate for a flow lies within the range [PRT, PRT+γ], or if the experiment duration is too short for the delay to fully stabilize (lines 8, 9, and 10), one can calculate the delay by determining how much of the input packet rate falls within the linear threshold. This value is then used to compute the delay (line 11). If the packet rate exceeds the linear threshold (LT), or if the experiment runs long enough for the delay to stabilize, the maximum delay is reached. This maximum delay is determined by the Packet Rate Threshold (PRT) for each flow. For example, if only the first flow [(1500, 5000)] is present, there would be no delay or packet loss since the total traffic rate remains below the available bandwidth. However, once a second flow is introduced, delays arise. One limitation is that it is assumed that the entire link bandwidth is dedicated to a single flow. In reality, each flow uses only a portion of the bandwidth, so the actual delay for a flow is less than what would occur if the flow were utilizing the full bandwidth. Therefore, one can adjust the delay by calculating the fraction of bandwidth used by each flow (lines 12, 14). Given that each experiment lasts for 12 seconds, one can divide the calculated delay by the total experiment duration (0) to account for the running time of the traffic in the network.

Here:
PRT is packet rate threshold (packet/second),
BW is bandwidth (Mb/second),
ML is message length (Bytes),
pr is the original packet rate (packet/second),
Delay is the end-to-end delay,
t is the total run time(s),
γ is the packet rate range that delay diagram has a linear shape until it reaches to its maximum value, and
δ and κ are the slope and intercept.

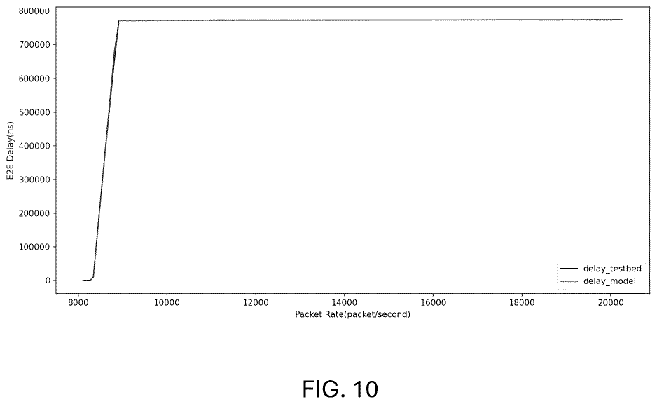

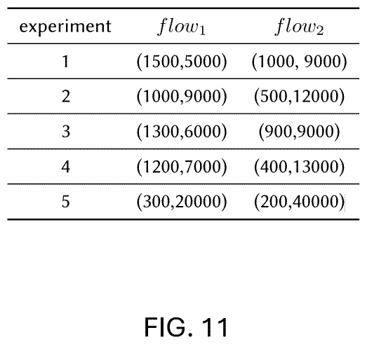

To validate the proposed delay model for router R1 140, experiments were conducted, beginning with a single flow to ensure the model's accuracy in simple scenarios before progressing to more complex ones. FIG. 10 illustrates the packet rate versus delay diagram for a single flow originating from router R1 140 in the network. The link bandwidth is 100 Mbps, and the message size is 1500 bytes. The model accurately predicts the delay in this router 140. Before the packet rate reaches 8333 packets per second, there is no congestion, so the delay remains low. However, during congestion, the linear model calculates the delay for each packet rate, and once it reaches the PRT, the delay remains constant at its maximum value. Next, the model is validated with more complex scenarios involving flows with varying packet sizes and packet rates. To advance this validation, scenarios are introduced that are slightly more complex by including two flows with different packet rates and packet sizes. Five different experiments were conducted, with the details of each provided in FIG. 11. The source of all flows is router R1 140, and the destinations are router R2 140 and R3 140. Individually, each flow is insufficient to cause link congestion, so the observed delay and loss result from the combined effect of these two flows.

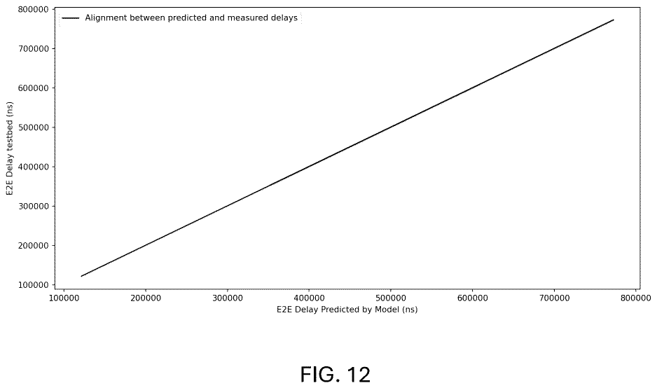

The delay model is represented in FIG. 12. The y-axis is the delay observed from router R1 140 and the x-axis is the delay calculated based on the model. As the diagram depicts, the linear relation between y-axis and x-axis indicates that the model can perfectly observe the behavior of this router 140. The same experiments were conducted on router R4 140, which belongs to the same family as router R1 140. The results were almost identical to those of router R1 140, further confirming the efficiency and accuracy of the introduced model for routers in this family. These findings demonstrate that the model is capable of accurately predicting end-to-end delay and congestion behavior across multiple routers the same series.

Thus, the present disclosure introduces a novel approach for improving the accuracy of network simulations by incorporating processing delay as a key factor in the calibration process. By integrating this parameter into the simulation model, the present disclosure was able to better align the simulated performance with real-world behavior, particularly in terms of end-to-end delay. Experiments demonstrated that the processing delay can significantly impact network performance and that neglecting it in network simulations can lead to inaccurate predictions, especially for modern, high-speed networks. The present disclosure successfully calibrated the model for routers from various series, showing improved accuracy in capturing their behavior. However, the case study involving another series highlighted the limitations of existing network simulation models when dealing with specific router behaviors. To address this, a new queueing model was proposed that more accurately reflects the behavior of routers of that family under complex traffic conditions.

Although the present disclosure is illustrated and described with reference to specific embodiments and examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims for all purposes.

What is claimed is:

1. A network simulation system comprising
a network simulation comprising instructions stored in a memory and executed by a processor to simulate an operation of a network, and
a processing delay model comprising instructions stored in a memory and executed by a processor to enable the network simulation to simulate the operation of the network incorporating processing delay, wherein the processing delay model comprises an objective calibration function,
wherein the network is operated responsive to the simulated operation of the network incorporating the processing delay.

2. The network simulation system of claim 1, wherein the network simulation simulates the operation of the network to determine predicted traffic delays in the network.

3. The network simulation system of claim 1, wherein the network simulation initially simulates the operation of the network not incorporating the processing delay using received initial network performance data and generating initial network simulation results.

4. The network simulation system of claim 3, wherein the processing delay model compares the generated initial network simulation results to received subsequent network performance data to estimate calibration values for the objective calibration function of the processing delay model.

5. The network simulation system of claim 4, wherein the processing delay model enables the network simulation to simulate the operation of the network incorporating processing delay via the objective calibration function using the estimated calibration values.

6. The network simulation system of claim 1, wherein the processing delay model compares the simulated operation of the network incorporating the processing delay to received subsequent network performance data to validate the simulated operation of the network incorporating the processing delay to ensure accuracy and reliability with respect to predicting the operation of the network.

7. The network simulation system of claim 1, wherein the network is operated responsive to the simulated operation of the network incorporating the processing delay using a digital twin network utilizing the simulated operation of the network of the network simulation.

8. The network simulation system of claim 1, wherein the processing delay model incorporates processing delay by accounting for both a constant base cost per packet and an additional cost proportional to packet size.

9. A network simulation method comprising
simulating an operation of a network using a network simulation comprising instructions stored in a memory and executed by a processor,
enabling the network simulation to simulate the operation of the network incorporating processing delay using a processing delay model comprising instructions stored in a memory and executed by a processor, wherein the processing delay model comprises an objective calibration function, and
operating the network responsive to the simulated operation of the network incorporating the processing delay.

10. The network simulation method of claim 9, wherein the network simulation simulates the operation of the network to determine predicted traffic delays in the network.

11. The network simulation method of claim 9, further comprising initially simulating the operation of the network not incorporating the processing delay using the network simulation and received initial network performance data and generating initial network simulation results.

12. The network simulation method of claim 11, further comprising comparing the generated initial network simulation results to received subsequent network performance data using the processing delay model to estimate calibration values for the objective calibration function of the processing delay model.

13. The network simulation method of claim 12, wherein the processing delay model enables the network simulation to simulate the operation of the network incorporating processing delay via the objective calibration function using the estimated calibration values.

14. The network simulation method of claim 9, further comprising comparing the simulated operation of the network incorporating the processing delay to received subsequent network performance data using the processing delay model to validate the simulated operation of the network incorporating the processing delay to ensure accuracy and reliability with respect to predicting the operation of the network.

15. The network simulation method of claim 9, wherein the network is operated responsive to the simulated operation of the network incorporating the processing delay using a digital twin network utilizing the simulated operation of the network of the network simulation.

16. The network simulation method of claim 9, wherein the processing delay model incorporates processing delay by accounting for both a constant base cost per packet and an additional cost proportional to packet size.

17. A non-transitory computer-readable medium comprising instructions stored in a memory and executed by a processor to carry out network simulation method steps comprising
simulating an operation of a network using a network simulation comprising instructions stored in a memory and executed by a processor,
enabling the network simulation to simulate the operation of the network incorporating processing delay using a processing delay model comprising instructions stored in a memory and executed by a processor, wherein the processing delay model comprises an objective calibration function, and
operating the network responsive to the simulated operation of the network incorporating the processing delay.

18. The non-transitory computer-readable medium of claim 17, wherein the network simulation simulates the operation of the network to determine predicted traffic delays in the network.

19. The non-transitory computer-readable medium of claim 17, wherein the network simulation method steps further comprise initially simulating the operation of the network not incorporating the processing delay using the network simulation and received initial network performance data and generating initial network simulation results.

20. The non-transitory computer-readable medium of claim 19, wherein
the network simulation method steps further comprise comparing the generated initial network simulation results to received subsequent network performance data using the processing delay model to estimate calibration values for the objective calibration function of the processing delay model, and
the processing delay model enables the network simulation to simulate the operation of the network incorporating processing delay via the objective calibration function using the estimated calibration values.
